(19) United States
(12) Patent Application Publication
(10) Pub. No.: US 2008/0100705 A1
(43) Pub. Date: May 1, 2008

(54) Method and apparatus for notifying one or more networked surveillance cameras that another networked camera has begun recording

(76) Inventors: Thomas F. Kister, Chalfont, PA (US); Michael R. Wimberly, Sammamish, WA (US)

Correspondence Address: Motorola, Inc.;Law Department, 1303 East Algonquin Road, 3rd Floor, Schaumburg, IL, 60196, US

(21) Appl. No.: 11/302,463

(22) Filed: Dec. 13, 2005

(51) Int. Cl. H04N 7/18

(52) U.S. Cl. 348/143

(57) ABSTRACT

A method and apparatus for use in a surveillance system having a plurality of remotely located cameras that are in communication over a data network. The method includes the steps of: receiving a first message over the data network associated with a change in imaging status of a first camera; and transmitting over the data network, in response to receipt of the first message, a second message to a second camera instructing the second camera to change its imaging status.

### FIELD OF THE INVENTION

The present invention relates generally to surveillance and monitoring systems, and more particularly to surveillance and monitoring systems that employ two or more surveillance cameras that communicate over a data network.

### BACKGROUND OF THE INVENTION

Electronic surveillance and monitoring systems are becoming more common and important in residential and commercial environments. Individuals and families, in particular, desire a security system that monitors a defined premises and/or environment, to prevent or deter theft, burglary and robbery. In addition, there is a desire to monitor and detect other defined conditions and, in response to a detected condition, generate a warning. These other potentially hazardous conditions or threats include, for example, fire hazards, carbon monoxide and power failure and electricity outages.

Surveillance and monitoring systems often include video cameras, which allow activity to be monitored for alerting the occurrence of unwanted activity or intrusions, for identification, for facilities management, and/or for providing a signal that may be recorded for later reference or potential use as evidence. Generally individual cameras are dedicated to different field of views such as different rooms, passageways, doors, and stairwells. The video cameras may be in continuous operation so that they are always recording what is in their field of view. However, because of the prodigious volume of data that may be recorded, the video cameras alternatively may be configured so that they only begin recording when motion is detected. Since there can be a latency between the time motion is detected and the camera begins recording, potentially valuable video data may be missed. For instance, sometimes one camera will begin recording before any others because it is the first to detect motion while a neighboring camera may be better situated to record important information that may be lost because it has not yet detected motion. Under such circumstances it could be helpful to reduce the response time of any of the cameras that may be able to record useful information, regardless of when they first detect motion.

A simple example will now be presented to facilitate a better understanding of the problem discussed above. If an intruder enters a residence through a living room window, but the living room camera only captures the intruder's back and not his face, little useful information is obtained. If the intruder then quickly crosses through the hallway and enters the dining room, the hallway camera may not respond sufficiently rapidly to begin recording before the intruder has left the hallway and entered the dining room. In this case valuable information that could have been obtained while the intruder is in the hallway will be missed. Accordingly, it would be helpful if when motion is first detected, thereby triggering the first camera in the living room, the hallway camera is also instructed to begin recording so that by the time the intruder has entered the hallway the hallway camera will be recording.

### BRIEF DESCRIPTION OF THE DRAWINGS

FIG. 1 shows a surveillance or inspection system in which a hub or base station is in communication with two or more video cameras over a wired or wireless data network.

FIG. 2 shows a block diagram of one example of the hub shown in FIG. 1.

FIG. 3 shows a floor plan of a residence in which video cameras are distributed among various rooms.

FIG. 4 is an example of the logical format of a message that may be communicated from a camera to the hub.

FIG. 5 is a flowchart showing one example of the surveillance or inspection system in operation.

### DETAILED DESCRIPTION

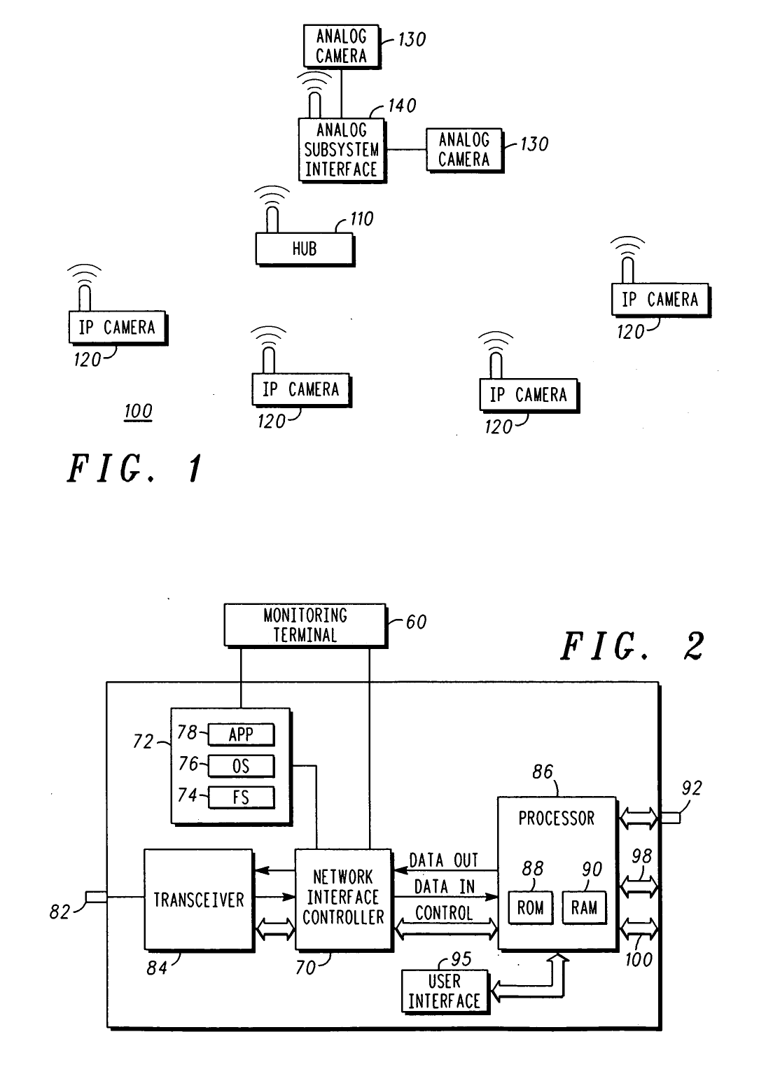

FIG. 1 shows a surveillance or inspection system 100 in which a hub or base station 110 is in communication with two or more video cameras 120 over a wired or wireless data network. The cameras may be distributed throughout a premises such as residence, office or building. Although not shown, surveillance system 100 may also include other components often found in surveillance systems 100 such as a console display/keypad, window and door sensors, motion detectors, alarms, environmental sensors (e.g. temperature monitors) and the like. The surveillance system 100 may even include automation capabilities to enable control of such things as lighting, heating and air conditionings, and networked appliances.

If surveillance system 100 operates over a wireless network, any of a variety of different physical and data link communication standards may be employed. For example, such systems may use, without limitation, IEEE 802.11 (e.g., 802.11a; 802.11b; 802.11g), IEEE 802.15 (e.g., 802.15.1; 802.15.3, 802.15.4), DECT, PWT, pager, PCS, Wi-Fi, Bluetooth™, cellular, and the like. While the surveillance system may encompass any of these standards, one particularly advantageous communication protocol that is currently growing in use is ZigBee , which is a software layer based on the IEEE standard 802.15.4. Unlike the IEEE 802.11 and Bluetooth standards, ZigBee offers long battery life (measured in months or even years), high reliability, small size, automatic or semi-automatic installation, and low cost. With a relatively low data rate, 802.15.4 compliant devices are expected to be targeted to such cost-sensitive, low data rate markets as industrial sensors, commercial metering, consumer electronics, toys and games, and home automation and security.

Hub 110 may be implemented as a base station, router, switch, access point, or similar device that couples network devices. While the IP protocol suite is used in the particular implementations described herein, other standard and/or communication protocols are suitable substitutes. For example, X.25, ARP, RIP, UPnP or other protocols may be appropriate in particular installations. The IP protocol suite operates within the network layer of the International Standard Organization's Open System Interconnect model. In this system, packets of data transmitted through a network are marked with addresses that indicate their destination. Established routing algorithms determine an appropriate path through the network such that the packet arrives at the correct device. Packets also contain information that indicates the address of the sending device that the receiving device may use to reply to the transmitter. Even within the IP protocol suite, a variety of different standard and/or proprietary transport protocols may be employed (e.g., TCP, UDP, RTP, DCCP).

Hub 110 may implement any number of ports to meet the needs of a particular application, and may be implemented by a plurality of physical devices to provide more ports and/or a more complex network including sub-networks, zones, and the like. Hub 110 may also include additional functionality such as those normally offered by a conventional surveillance system controller. Alternatively, the functionality of the controller may be provided by one or more separate components. If cameras 120 and 130 transmit video and/or audio data to the hub 110 (as opposed to storing the data locally in the individual cameras), other devices that may associated with hub 110 includes a server for storing the data and a monitor that provides an operator with a centralized location from which to view the scenes from the various cameras

FIG. 2 shows a block diagram of one example of hub 110. In this example the network over which hub 110 and cameras 120 and 130 communicate is assumed to be a wireless network. The hub 110 includes an antenna port 82, RF front-end transceiver 84, network interface controller 70, microprocessor 86 having ROM 88 and RAM 90, and programming port 92. The configuration of front-end transceiver 84 will depend on the particular physical and data link communication standards that are employed by the wireless network. For instance, if the wireless network is ZigBee compliant, front end transceiver 84 may be a ZigBee transceiver of the type that is widely available from a number of manufacturers, including Motorola. Network interface controller 70 may include the functionality of a switch or router and also serves as an interface that supports the various communication protocols, e.g., IP, that are used to transmit the data over the wireless network. The hub 110 may also include RAM port 98 and ROM port 100 for, among other things, downloading various network configuration parameters, distribution lists (discussed below), and upgrading software residing in the processor 86. User interface 95 (e.g., a keypad/display unit) allows control of the various user-adjustable parameters of the hub 110.

In the particular example of FIG. 2, hub 110 is also shown to include a server 72 for receiving compressed video data and/or audio data from the cameras 120 and 130. The server 72 may be, for example, a personal computer, and comprises a file system 74 (such as a hard disc drive or array) capable of storing received compressed audio and video, an operating system 76 controlling the file system 74 and an application program 78 running on the server 72. Under the control of the operating system 76 and the application 78, compressed audio and video received by the server 72 from the cameras 120 and 130 are stored on the file system 22. It will be appreciated that there may be more than one server 72 to store the compressed data and that the need for a certain number of servers 18 may be determined by, for example, bandwidth constraints, backup requirements etc. Of course, the individual cameras 120 and 130 may also store the data in addition to, or instead of server 72.

A monitoring terminal 60 is also associated with hub 110. The monitoring terminal 60 may be used to view in real time the audio and video captured by any of the cameras 120 and 130 as well as video and audio stored on server 72.

In FIG. 1 cameras 120 are depicted as IP cameras that implement their own IP interfaces and have their own network address. Such cameras are widely available from a variety of different manufacturers. That is, with IP cameras, hub 110 may send commands to a particular camera by transmitting packets marked with its IP address. Cameras 120, in turn, send information, including possibly video data, to hub 110 by transmitting packets marked with the hub's IP address. The hub may broadcast packets to more than one camera by using broadcast aspects of the Internet Protocol. Of course, instead of an IP interface, the cameras may have other network interfaces that implement any other appropriate communication protocol that may be used by the surveillance system 100, such as those protocols mentioned above.

Alternatively, instead of network-enabled cameras such as cameras 120, some or all of the cameras may be analog cameras that communicate with hub 110 using an analog subsystem interface that implements control functions and provides a network interface for cameras that do not communicate using standard network protocols. For example, in FIG. 1 analog camera 130 communicates with hub 110 through analog subsystem interface 140.

Some or all of the cameras 120 and 130 may be fixed in position or they may be tracking cameras that are secured to a pan-tilt positioning unit (not shown in FIG. 1) that allows the camera to change its orientation as needed to view different scenes or to follow an object.

IP cameras 120 are configured to generate a message that is transmitted to hub 110 whenever the camera is activated by detecting motion or by other means such as the activation of a co-located mechanical sensor (indicating that a door or window has been opened), thermal detector, glass breakage sensor, environmental sensor or monitor and the like. The message may conform to any transport or application layer protocol in the IP protocol suite that can be used to control and configure network devices such as UDP, TCP, FTP, SMTP and the like. If a different communication protocol is employed, the messages may be transmitted in any format appropriate for that protocol. For example, if the UPnP protocol is employed, the messages may be sent as XML messages.

In operation, when any of the cameras 120 and 130 are activated or otherwise undergo a change in imaging status (e.g., on/off, change in orientation such as a pan or tilt) by detecting motion or other means, a message is transmitted by the camera to the hub 110. The message identifies the camera that has undergone a change in imaging status and possibly provides other pertinent information, if available. For instance, if the camera that is activated has pan and tilt mechanisms, the message may include the camera orientation or the coordinates identifying the precise location that the camera was viewing when it was activated. Such information could assist other cameras in rapidly orienting themselves to view the scene that caused the first camera to be activated. For instance, if a stairwell camera located at the top of the stairs receives a message indicating that a camera on the first floor has been activated or has otherwise undergone a change in imaging status, the stairwell camera may be instructed to tilt downward.

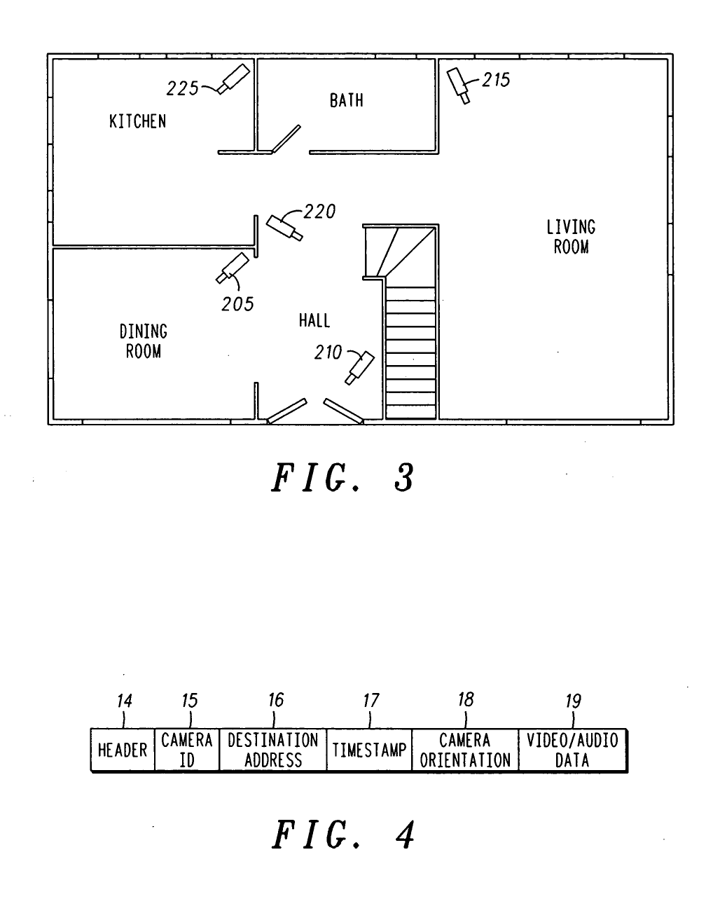

The operation of the cameras as discussed above can be further illustrated using FIG. 3, which shows a floor plan for a first floor of a residence. As shown, security cameras 205, 210, 215, 220 and 225 are located in the dining room, hallway, living room, stairwell and kitchen, respectively. Continuing with the previously mentioned example, if hall camera 210 undergoes a change in imaging status, a message will be forwarded to stairwell camera 220 both activating it and directing it to tilt down the staircase, since presumably there may be an intruder in the hallway who may attempt to gain access to the second floor.

Upon receipt of a message from the hub 110, hub 110 forwards the information to one or more of the other cameras, either by forwarding the original message or generating a new message. Instead of forwarding all or part of the information itself, the hub 110 may simply forward a command instructing one or more of the cameras to begin recording, or more generally, undergo some change in its imaging status. The cameras that are selected to receive the message can be determined in any of a number of different ways. For example, only those cameras in the same vicinity (e.g., the same room or same side of a building) or that have overlapping fields of view as the initially activated camera may receive the message. In this case the hub 110 can be preprogrammed, either by the user or a technician, with a distribution list that is appropriate for each camera. The distribution list can be stored, for example, in ROM 88 so that it is available for access by processor 86. The hub 110 can be programmed by downloading the distribution list using, for instance, either ROM port 100 or programming port 92. For instance, if camera “A” is activated, hub 110 may have a distribution list stored in ROM 88 instructing it to inform cameras “B” and “D.” Likewise, if camera “E” is activated, hub 110 may have a distribution list stored in ROM 88 instructing it to inform cameras “A” “F” and “G.” In the particular example shown in FIG. 3, dining room camera 205 may have hall camera 210 and kitchen camera 225 on its distribution list since these cameras are located in adjoining rooms.

The distribution list may be a static distribution list or a dynamic distribution list. In a static distribution list, the cameras that are selected to receive the message always remains the same (unless reprogrammed, of course). For example, the distribution list for a given camera may list all adjacent rooms. In a dynamic distribution list, the cameras included on the distribution list may vary depending on the particular circumstances or conditions under which the camera maintaining the list is activated. For instance, returning to the floor plan shown in FIG. 3, if stairwell camera 220 is activated while it is viewing the second floor of the residence, it may include on its distribution list all cameras located on the second floor but not those on the first floor. On the other hand, if the stairwell camera 220 is oriented down the stairwell so that it is viewing the first floor hallway at the time it is activated, the stairwell camera's 220 distribution list may include all first floor cameras as well as the second floor cameras.

The hub 110 may include a memory that stores an electronic map or relational database of the premises so that it can correlate the cameras to be included in the dynamic distribution list. Of course, such an electronic map or relational database can be used for other purposes as well. For instance, the electronic map or relational database may be used to correlate the orientation information that is to be forwarded from one camera to another.

Alternatively, instead of using a distribution list, hub 110 may simply forward the information to all the cameras or even determine the cameras to be notified on some dynamic basis (e.g., the particular coordinates of the event being observed, the time of day, a likely path through the premises that may be traversed by a hypothetical intruder).

As previously mentioned, if orientation information is available in the message from the initially activated camera, the hub 110 may forward on this information in its subsequent messages to the other cameras, thereby allowing the individual cameras to determine its corresponding coordinates of the appropriate location that is to be viewed. Alternatively, the hub may use the orientation information from the initially activated camera to determine the appropriate orientation to be taken by the other cameras that are notified by the hub 110. This can be accomplished using, for instance, a relational database (e.g., the aforementioned electronic map of the premises) stored in hub 110 and accessible to processor 86, which relates corresponding coordinates of the various cameras 120 and 130 when viewing the same location. Instead of a database relating coordinates of each camera to one another, this information may be provided in terms of a coordinate transformation that the processor 86 can perform between any two of the cameras to ensure that they view the same location. In any case, once the hub determines the appropriate orientation for each of the cameras, this information can be included in the messages they are sent instructing them to begin recording.

It should be noted that if the orientation information (e.g., coordinates) that is transmitted in the message is specific to the camera receiving the message, the content included in the messages will generally differ from camera to camera. Of course, the content that is transmitted to the various cameras may differ in other ways as well and is not limited to different orientation information.

Upon receipt of a message from the hub 110, the receiving camera(s) is activated and begins recording. If the message includes the coordinates of the location that the initial camera was viewing when it was activated, the receiving camera may orient itself to view the same location or even a different but generally nearby location that may yield more useful information.

FIG. 4 is an example of the logical format of a message that may be communicated from a camera to the hub. Depending on the protocol that is employed, the message may be transmitted as packets or frames of information. The message shown in FIG. 4 may be included in a single packet or multiple packets. The packets itself consists of a variable number of octets, and is divided into fields of an integral number of octets as shown. The nomenclature and purpose of the fields is as follows. The header 14 is a unique pattern used to synchronize the reception of packets. The camera ID 15 identifies the camera that is sending the message. The destination address 16 may be that of the hub 10 and/or the cameras that are to receive the message. The timestamp 17 indicates the time that the camera began recording or the time at which the message was sent. The camera orientation 18 includes any coordinate or other information that indicates the camera's position when it began recording. The data 19 refers to any additional information that may be communicated, such as video and/or audio data that that camera has obtained.

In some cases it may be desirable to turn off or otherwise deactivate the cameras so that they stop recording if a period of time have elapsed during which there has been no subsequent detection of motion or other activity that may have been used to initiate the recording process. If there has been no such activity for say, ten or fifteen minutes (or some other timeout period) the recording process can be terminated since presumably the intruder has already left the premises. Alternatively, the motion or other activity that first triggered or activated the cameras may have been due to some event other than an intruder such as a tree falling through a window, a loud noise or the like, in which case there once again is no reason to continuing the recording process.

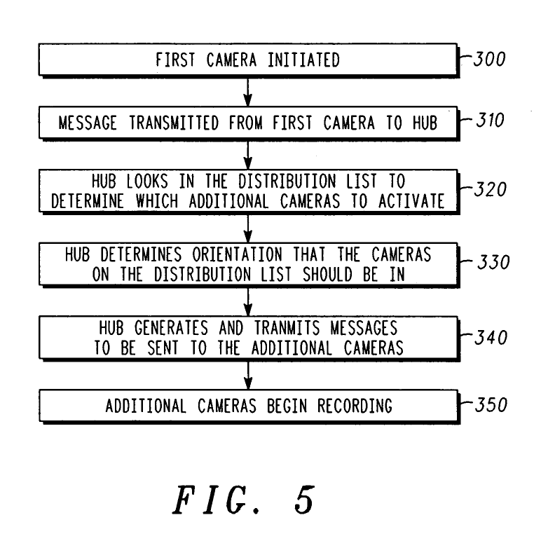

FIG. 5 is a flowchart showing one example of the surveillance system in operation. The process begins in step 300 when one of the cameras is activated and begins recording upon the occurrence of a triggering event such as the detection of motion. Upon activation, in step 310 the camera transmits a message from the first camera to the hub. In this example the message includes the orientation of the camera when it is viewing the event that gave rise to its activation. Next, in step 320 the hub examines the distribution list and determines which additional cameras are to be notified. In this particular example, in step 330 the hub uses the orientation data from the first camera that was activated to calculate appropriate orientations for additional cameras so that they can best view the event that gave rise to its activation or so that they can view a scene anticipated to provide any useful information. The hub than generates and transmits the appropriate messages to the additional cameras in step 340. Finally, in step 350, the additional cameras begin recording as directed by the hub.

1. A method of surveillance using a plurality of remotely located cameras that are in communication over a data network, comprising:
receiving a first message over the data network associated with a change in imaging status of a first camera; and
transmitting over the data network, in response to receipt of the first message, a second message to a second camera instructing the second camera to change its imaging status.

2. The method of claim 1 wherein the change in imaging status of the first camera is to an imaging state that is entered upon occurrence of a triggering event.

3. The method of claim 1 wherein the triggering event is detection of motion.

4. The method of claim 1 wherein the detection of motion is performed by the first camera.

5. The method of claim 1 wherein the triggering event is performed by a sensor distinct from the first camera.

6. The method of claim 1 wherein the change in imaging status comprises camera activation.

7. At least one computer-readable medium encoded with instructions which, when executed by a processor, performs a method including the steps of:
receiving a first message over a data network reflecting a change in imaging status of a first camera; and
transmitting over the data network, in response to receipt of the first message, a second message to a second camera instructing the second camera to change its imaging status.

8. The computer-readable medium of claim 7 wherein the change in recording status of the first camera is to a recording state that is entered upon occurrence of a triggering event.

9. The computer-readable medium of claim 7 wherein the triggering event is detection of motion.

10. An apparatus for facilitating communication among a plurality of cameras, comprising:
a network interface for transmitting and receiving messages over a data network;
a first memory segment capable of storing a network address for at least one of the plurality of cameras; and
a processor for receiving a first message over the data network reflecting a change in imaging status of a first camera and, in response thereto, retrieving a network address of at least one other camera from the first memory segment to generate a second message to be transmitted over the data network to the other camera instructing the other camera to change its imaging status.

11. The apparatus of claim 10 further comprising a second memory segment capable of storing a distribution list for each of the plurality of cameras listing selected other cameras that are to be notified when a message is received from each respective camera and wherein, upon receiving the first message from the first camera, the processor retrieves the distribution list associated with the first camera and generates a second message to be sent to each camera listed on the distribution list associated with the first camera.

12. The apparatus of claim 11 wherein the distribution list is a dynamic distribution list.

13. The apparatus of claim 11 wherein the distribution list is a static dynamic list.

14. The apparatus of claim 11 wherein at least two of the second messages have content that differ from one another.

15. The apparatus of claim 14 wherein the different content comprises different coordinates of different locations to be viewed.

16. The apparatus of claim 14 wherein the different content comprises different coordinates corresponding to a common location to be viewed by cameras situated at different locations to be viewed.

17. The apparatus of claim 11 further comprising a third memory segment capable of storing relational information pertaining to a relative orientation of the plurality of cameras with respect to one another, and wherein the processor accesses the third memory segment to determine coordinates of a location to be viewed by the other camera, and wherein the coordinates are included in the second message transmitted to the other camera.

18. The apparatus of claim 10 wherein the first message includes information establishing an orientation of the first camera upon occurance of the change in recording status.

19. The apparatus of claim 10 wherein the second message includes information directing the second camera to be oriented to view a prescribed scene.

20. The apparatus of claim 10 wherein the second message is transmitted to a plurality of the other cameras.

21. The apparatus of claim 20 wherein the plurality of other cameras to which the second message is transmitted is based on a predetermined distribution list.

22. The apparatus of claim 10 wherein the data network is a wireless network.

23. The apparatus of claim 10 wherein the cameras are IP cameras.
